(19) United States
(12) Patent Application Publication
(10) Pub. No.: US 2013/0075466 A1
(43) Pub. Date: Mar. 28, 2013

(54) METHOD AND SYSTEM OF RAPIDLY CASHING A CHECK AND LOADING THE PROCEEDS ONTO A CONSUMER ELECTRONIC ACCESS DEVICE VIA A MOBILE SMART DEVICE

(71) Applicants: Agartha S. Clark, Des Moines, WA (US); James Grabow, Newport, CA (US); Joe Morris, La Quinta, CA (US)

(72) Inventors: Agartha S. Clark, Des Moines, WA (US); James Grabow, Newport, CA (US); Joe Morris, La Quinta, CA (US)

(73) Assignee: Moneytree, Inc., Seattle, WA (US)

(21) Appl. No.: 13/600,004

(22) Filed: Aug. 30, 2012

Related U.S. Application Data
(60) Provisional application No. 61/537,769, filed on Sep. 22, 2011.

(51) Int. Cl. G06Q 40/02

(52) U.S. Cl. 235/379

(57) ABSTRACT

A system and method of enabling mobile image capture of a check to be presented for cashing by a consumer to a check casher via a mobile smart device, net of fees, onto the consumer's access device such as a prepaid or stored value card. The consumer enters its credential information and transmits the information to a check casher through the computer network. Once verified, the consumer enters the check amount to be cashed, agrees to the check casher's fees, endorses the check, and captures a high resolution image of the front and back of the check. A high resolution image of the front and back sides of the check is transmitted to the check casher. If approved, the full check proceeds, less the agreed to check casher's fees, are loaded onto the consumer access device for immediate use.

### RELATED INVENTION

The present application claims the benefit of priority to U.S. Provisional Patent Application No. 61/537,769, filed on Sep. 22, 2011, and entitled “Method and System of Rapidly Cashing a Check and Loading the Proceeds onto a Consumer Electronic Access Device via a Mobile Smart Device.”

### TECHNICAL FIELD

The present invention relates generally to mobile check cashing. More particularly, the present invention relates to a method and system for rapidly cashing a check by a check casher and loading the full amount of the check proceeds, less check casher fees, onto a consumer electronic device, such as a prepaid card, all via a wireless smart device.

### BACKGROUND OF THE INVENTION

Mobility is the new norm in financial transactions. Mobile check deposit transactions can be made remotely with a federally insured deposit institution (i.e., a bank) via a smart device that has an image capture feature. However, banks generally do not allow a consumer to have access to the full amount of the check until the check clears, usually 1-2 or more days.

Check cashers, which are not federally insured depository institutions, are generally state-licensed financial services providers that cash checks for consumers for a fee. If the check is approved for cashing by a check casher, the full amount of the check, less the check casher's fee, is given to the consumer. These check cashing transactions are typically done in person at a check casher retail store.

Heretofore, there has been no mobile check cashing process where full check proceeds are rapidly available (e.g., in approximately 15 minutes) from a remote location to a consumer for immediate use on a consumer electronic funds access device, such as a prepaid card or stored value card.

### SUMMARY OF THE INVENTION

The present invention is directed to a method and system of allowing a consumer to rapidly cash a check through a check casher and load the full amount of the cashed check, less check cashing fees, onto the consumer's electronic access device having an identification number, such as a prepaid card.

The consumer utilizes a smart device, such as a wireless smartphone, that is enabled to communicate via a wireless communications network, to accept data input, capture images and be able to transmit the images and data over the wireless communications network. The consumer enrolls by entering information, including the consumer's name and location, electronic contact information and security information and electronic access device identification number, into the smart device. This information is sent by the smart device to a display screen through which the smart device can communicate with a check casher and from which the check casher can access the information transmitted by the smart device. The check casher approves the enrollment of the consumer's electronic access device and ties the smart device to the enrolled electronic access device.

Once enrollment has taken place, the consumer may begin mobile check cashing at any time. According to one embodiment of the invention, the consumer may begin mobile check cashing by successfully passing through a security screen by entering its security information given at the enrollment phase. This security information may be a user name and a password. The consumer then enters the amount of check, which calculates the amount of the total check cashing fees. If the consumer agrees to the fees, the consumer is then instructed to endorse the back of the check, take an image via the smart device of the front and back of the check, and transmit the images to the check casher. The check casher does either one of two things: (i) approves the check and promptly downloads the full amount of the check, less the agreed to check cashing fees, onto the consumer's consumer access device or (ii) refuses to approve the check for cashing in which case the consumer may be invited to further contact the check casher for determination of options or end the transaction.

According to one aspect of the invention, the consumer's electronic access device is a prepaid card.

These and other advantages will become more apparent upon review of the Drawings, the Detailed Description of the Invention, and the Claims.

### BRIEF DESCRIPTION OF THE DRAWINGS

Like reference numerals are used to designate like parts throughout the several views of the drawings, wherein:

FIG. 1 is a flow chart of a method and system for cashing a check transmitted by a mobile smart device and where the full proceeds of the check are accessible by a consumer's access device, such as a prepaid card;

FIG. 2 is a network illustrating an example location in which aspects of the present disclosure can be implemented;

FIG. 3 illustrates an example graphical user interface of cashing a check under the method and system of the present invention where the user can be identified as a first time or existing customer;

FIG. 4 illustrates an example graphical user interface where the first time customer provides credential information and ties the smart device to at least one customer access device;

FIG. 5 illustrates an example graphical user interface where the customer supplies credential information to further continue the check cashing method and system;

FIG. 6 illustrates an example graphical user interface where the customer can access a main menu to begin the check cashing and loading functions;

FIG. 7 illustrates an example graphical user interface where the customer enters the amount of the check to be cashed;

FIG. 8 illustrates an example graphical user interface where the customer is shown a check casher's fee calculation and may accept or decline the terms and can view the correct customer access device to which the check proceeds, net of fees, would be loaded if the check is accepted for cashing;

FIG. 9 illustrates an example graphical user interface where the customer is instructed to endorse the back of the check;

FIG. 10 illustrates an example graphical user interface where the customer is instructed to take an image of the front of the check via the smart device and transmit to the host computer network;

FIG. 11 is a pictorial view of a user's smart device capturing in electronic form an image of the front of the check;

FIG. 12 illustrates an example graphical user interface where the customer is instructed to take an image of the back of the check and transmit to the host computer network;

FIG. 13 is a pictorial view of a user's smart device capturing in electronic form an image of the back of the check and transmitting it to the host computer network;

FIG. 14 illustrates an example graphical user interface where the customer may review the status of the transmission of the captured check images;

FIG. 15 illustrates an example graphical user interface where the customer is notified of successful transmission of the captured check images;

FIG. 16 illustrates an example graphical user interface where the customer is notified of an unsuccessful transmission of the captured images and has an opportunity to recapture the images;

FIG. 17 illustrates an example graphical user interface where the customer can review the status of the check cashing request;

FIG. 18 illustrates an example graphical user interface where the customer is notified that the check has been accepted and is given a receipt of the amount of the check proceeds loaded onto the customer's access device for immediate use;

FIGS. 19 and 20 illustrate example graphical user interfaces where the customer optionally may review the front and back of the cashed check;

FIG. 21 illustrates an example graphical user interface in the event that the customer is notified that the check is not accepted;

FIG. 22 illustrates an alternate graphical user interface in the event that the customer is notified that the check is not accepted and given additional instructions by the check casher.

### DETAILED DESCRIPTION OF THE INVENTION

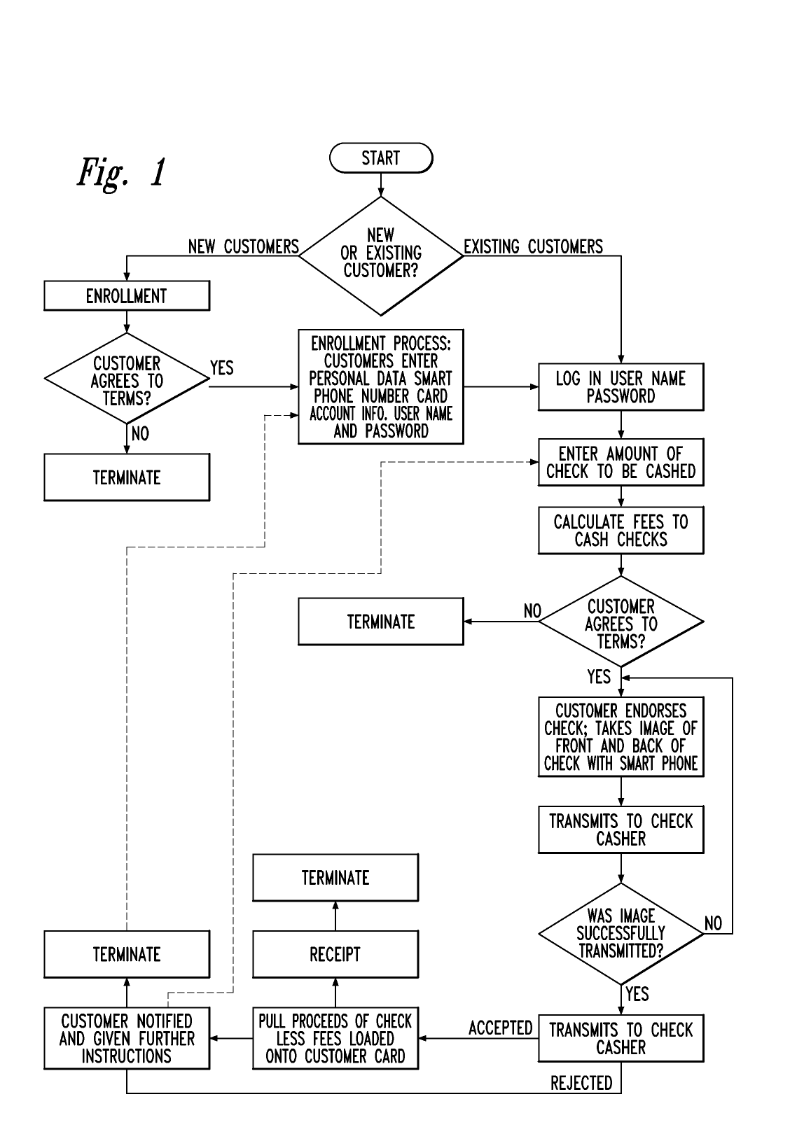

Referring to FIGS. 1 and 2, the invention is directed to a method and system to allow consumers to present a check for cashing to a check casher via a mobile smart device (e.g., a smart phone) and where the consumer has rapid access to the full amount of the check, less check cashing fees/convenience fees, and the proceeds are loaded onto the consumer's access device, such as a prepaid or stored value card. In this way, the consumer has immediate access to the full amount of the cashed check, net of fees, from any location from which a mobile device can operate.

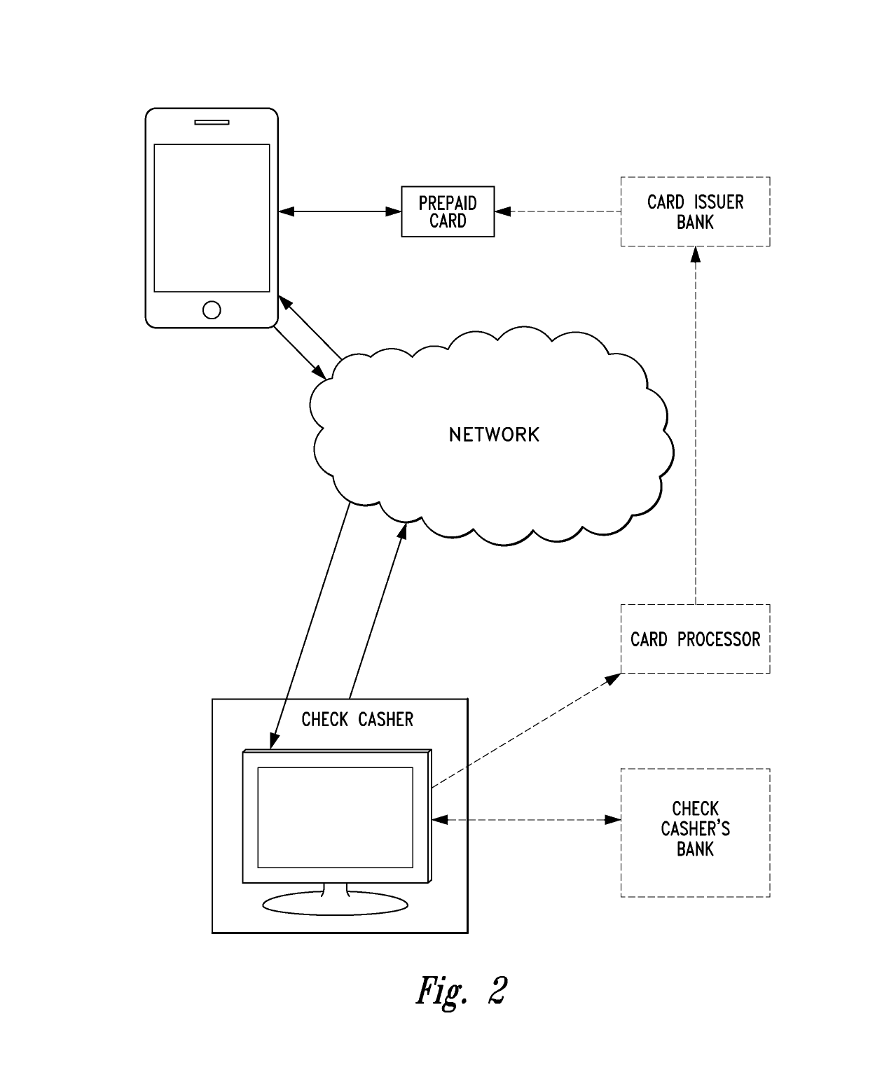

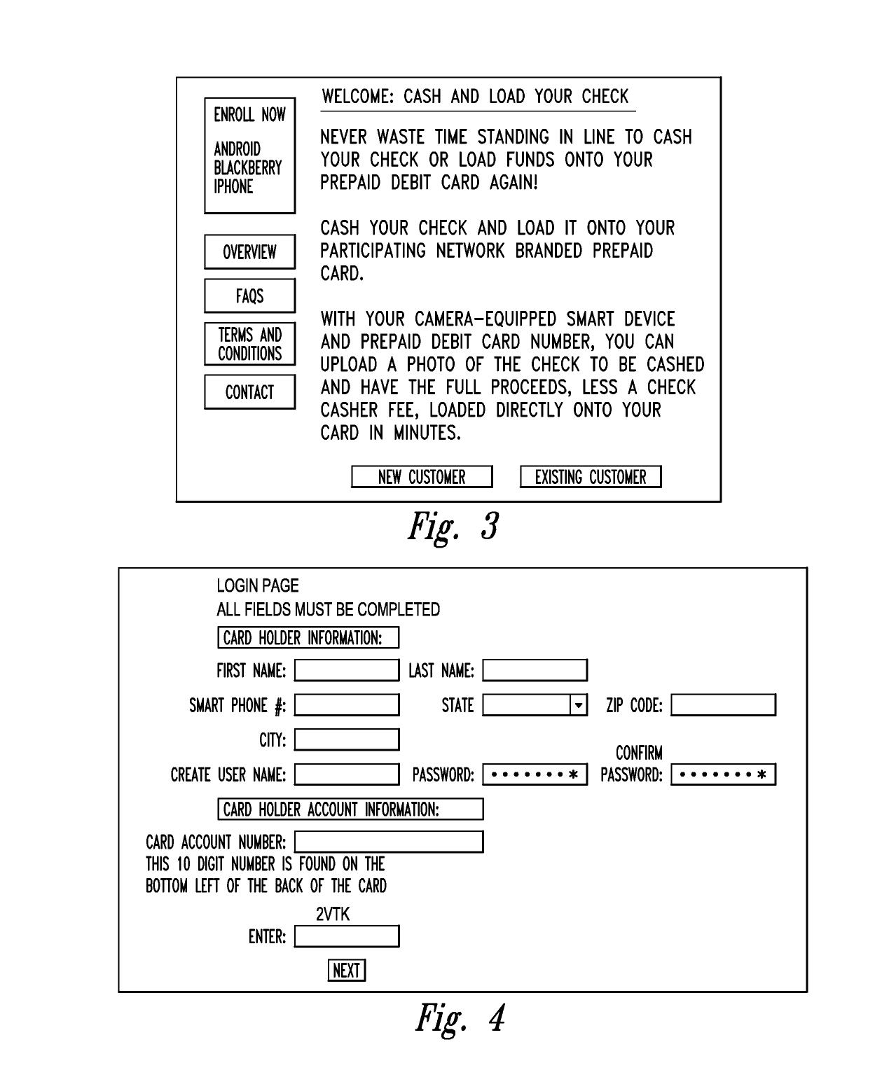

Referring also to FIGS. 3-6, the consumer utilizes its smart device that is communicatively connected directly or indirectly to a check casher via a computer network. In one embodiment, the consumer may communicate indirectly with the check casher via a hosted computer network.

Here, the term “smart device” is to be broadly construed and is intended to mean any mobile device that is capable of creating and transmitting a high resolution image as well as sending and receiving other data over the Internet or other communication network. A non-exhaustive list of smart devices includes the following devices: Apple IPHONE, Apple IPOD, Apple IPAD, Research in Motion BLACKBERRY, and Google's ANDROID phone. Electronic readers recently have had significant capability upgrades and are envisioned to be included as a “smart device” for the purposes of this invention. These devices have built-in cameras that allow them to take an image (e.g., a photo) and transmit it to a remote location. Further, these devices can download new software applications or “apps” that allow the device to function as a remote computer having a display and where the user or a remote source can send inputs to the device to act on the input.

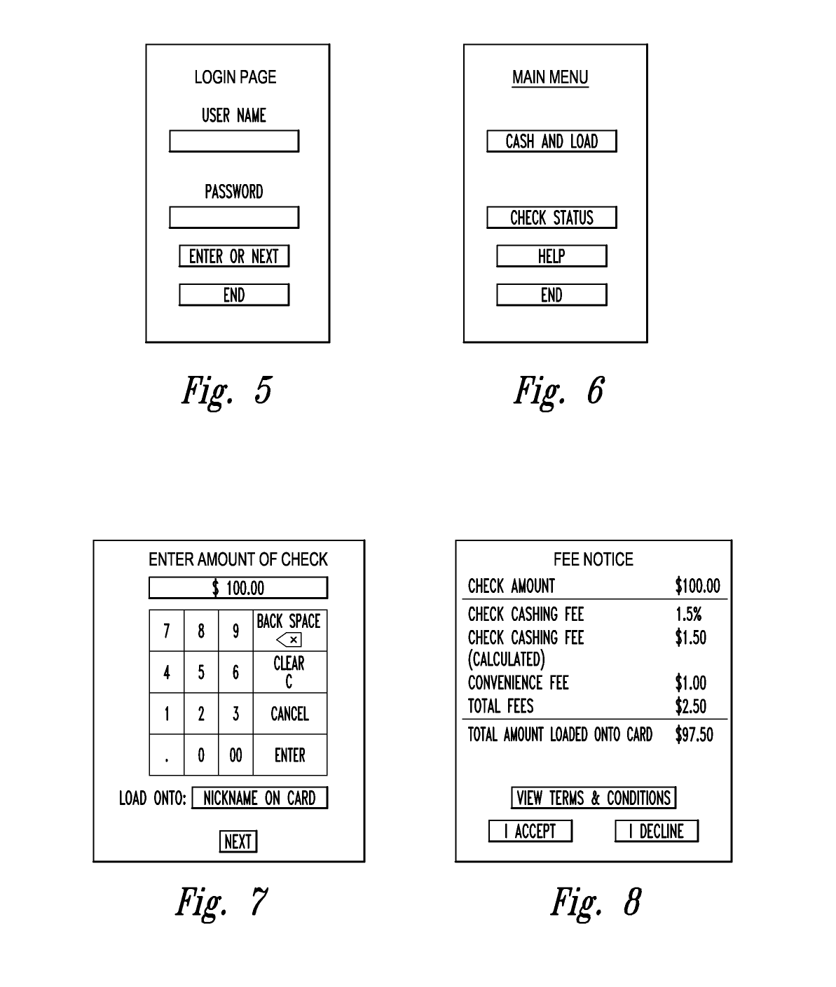

As illustrated in FIG. 3, the consumer may first be welcomed by a general information page that also requests input if the consumer is a new customer or an existing customer. If the consumer is a new customer, he or she is directed to an enrollment screen as illustrated in FIG. 4. If the consumer is an existing customer, he or she may pass over the enrollment process and go to the main menu, such as that illustrated in FIG. 6. The process may include an optional first step of logging in as a security measure such as that illustrated in FIG. 5.

Referring particularly to FIG. 4 as well as to FIG. 2, at enrollment the consumer as a new customer is instructed to enter the customer's credential information via the smart device (e.g., keyed in by a keypad on the smart device) or may alternatively “enroll” at a separate computer that is communicatively connected to the check casher via the computer network. The new customer supplies information regarding his or her identity, area of residence, the number assigned to the smart device (e.g., a 10-digit phone number), an electronic contact (e.g., e-mail address) for notification purposes, and number of the customer's access device. The customer's access device may be a prepaid debit or stored value card that once loaded with funds is a cash substitute and may be used in any e-commerce transaction or payment. The consumer access device normally can be identified as a 10 or 16-digit card number.

A check casher is licensed to cash checks by jurisdiction. The new customer provides its area of residence to determine which check casher may cash the check for that customer. In one form of the invention, the customer enters its full residential address. In another form of the invention, the consumer enters only a zip code or state of residence.

The consumer credential information is transmitted via the computer network (e.g., a hosted computer network) to a check casher authorized to cash checks where the consumer resides. The check casher, which is connected to the computer network, reviews the credential information and may check the consumer supplied credential information and consumer access device against one or more verifying databases. The check casher may notify the consumer that he or she is now a customer and may require that the customer review the check casher's terms and conditions, including its fee policies.

During this enrollment process, the customer may also provide other credential information, such as a user name and a password (for subsequent security log in to the check cashing and loading system). The customer may also provide the check casher security questions/answers in the event that a user name or password is forgotten. The customer may also provide a nickname of its customer access device (e.g., the prepaid card) as a means of identifying the card without the need to show the 10 or 16 digit access device. The customer may also enter multiple customer access devices, if applicable, to allow the customer an option of which customer access device onto which he or she would like to load the check proceeds. Each customer access device may also be assigned a nickname.

In an alternate embodiment, the consumer may be invited to review terms and conditions pertaining to the check cashing and loading process. This consumer's acceptance of the terms and conditions may be a condition for the consumer to be move forward as a customer and be able to access the check cashing and loading method and system.

Referring now to FIGS. 5 and 6, once a customer has completed the enrollment process, the customer is then able to access the check cashing and loading function. In one form of the invention, the customer enters his or her user name and password into a separate log in screen (FIG. 5) that may be accessed from an optional welcome/introductory screen, such as illustrated in FIG. 3. Once the user name and password are verified, the customer is directed to the main menu (FIG. 6) that allows access to the core check cashing and loading functions.

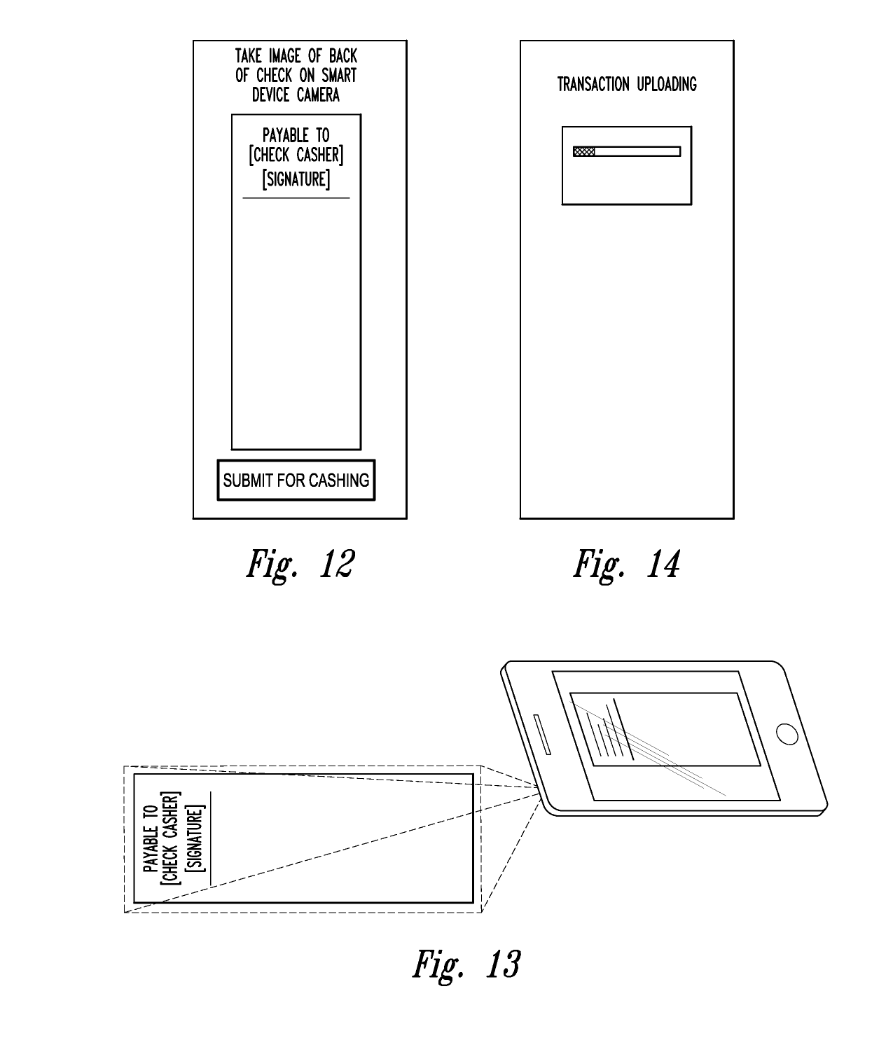

Referring now to FIGS. 7-22, when the customer is ready to cash a check and load the proceeds onto a customer access device, the amount of the check is keyed into the smart device as illustrated in FIG. 7. If applicable, the customer may also determine which customer access device the customer wants the check proceeds loaded onto. Otherwise, the customer access device will be identified by an optional nickname, the last four digits of the customer access device, or the full 10 or 16-digit access device number.

The customer is shown the check casher's fees and any convenience fees (collectively “check casher fees”) based on the check amount keyed in. For example as illustrated in FIG. 8, a $100.00 check being cashed may have a check cashing fee of 1.5% and a convenience fee of $1.00. The total check cashing fee in this example is $2.50 and, thus, the amount loaded onto the customer's access device of choice would be $97.50. The customer either accepts or rejects the fees. If accepted, the customer is taken to the next steps in the method and system. If the customer is declined, the transaction terminates. Optionally, the customer is given another opportunity to review the check casher's terms and conditions prior to acceptance.

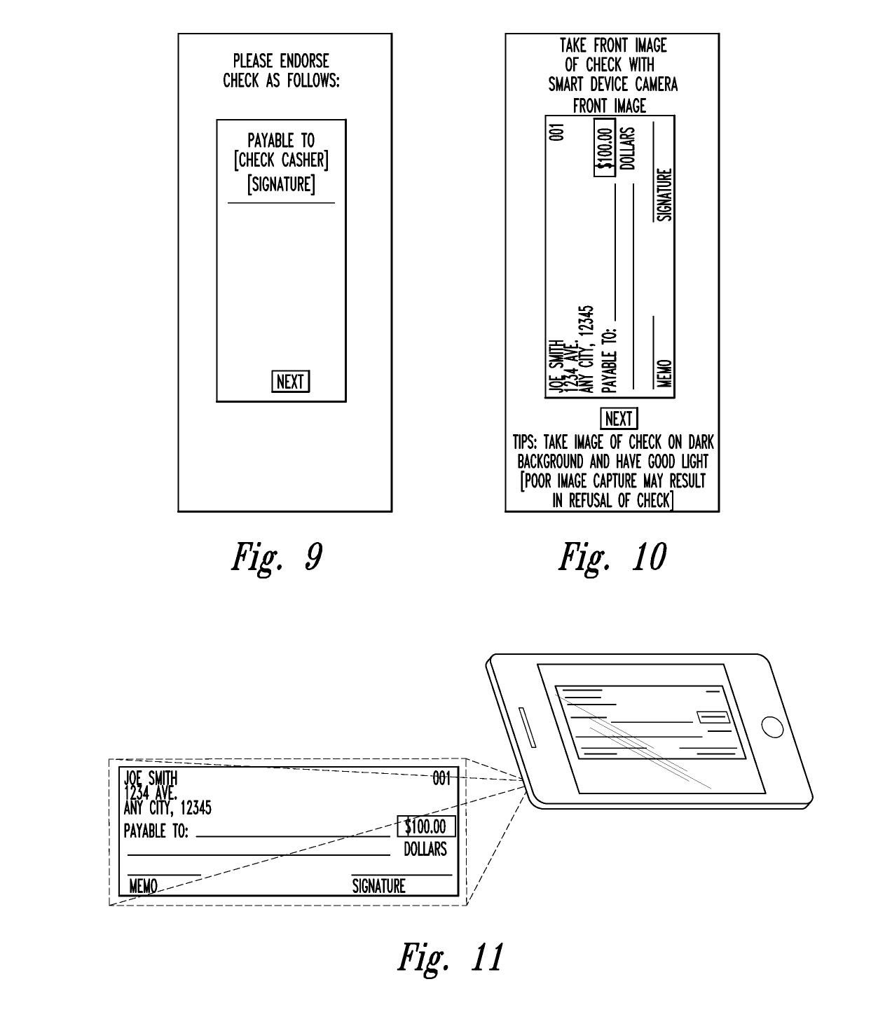

If the customer accepts the check casher fees, the customer is then instructed to endorse the back of the check as illustrated in FIG. 9 (e.g., “payable to [check casher] and the customer's signature”). The customer is then instructed to capture the front and back images of the signed check via a camera embedded in the smart device and transmit the images to the check casher via the hosted computer network as illustrated in FIGS. 10-13.

The check casher has a computerized display that allows the review of the front and back images of the check to determine whether the check should be approved or rejected. The check casher may verify the credential information, as well as the specific check information, against verifying databases. For example, if the check account that the check is being drawn from is known to be a stolen account, such information might be known to the check casher and the check request would be denied. The check casher might also request the customer to take an image of a piece of identification, such as a driver's license. Further, the check casher will review the captured check image for errors, such as the input information pertaining to the check amount not matching up to the amount on the check image or the check not being properly endorsed.

In one embodiment of the invention, a high resolution image of both the front and back of the check is transmitted to the check casher that can account for human error in taking images of a relatively small and flat article on a relatively small handheld camera/smart device. The present invention may include technology that accounts for geometric distortion and self-corrects such distortion. Such mobile image capturing and distortion correcting technology may be like that provided by Mitek Systems, Inc., of San Diego, Calif. Mitek has patented its remote check capture technology such as described in U.S. Pat. No. 7,778,457 to Nepomniachtchi et al., issued on Aug., 17, 2010 and entitled “Systems for Mobile Image Capture and Processing of Checks”, as well as U.S. Pat. No. 7,953,268 (issued May 31, 2011), U.S. Pat. No. 7,949,176 (issued May 24, 2011), U.S. Pat. No. 7,978,900 (issued Jul. 12, 2011), and U.S. Pat. No. 8,000,514 (issued Aug. 16, 2011), all of which are hereby incorporated by reference. Nepomniachtchi discloses where the consumer takes a bi-tonal, high resolution image of the front and back sides of the check which may be geometrically corrected in accordance with the patented technology.

The high resolution images are transmitted via the smart device to a hosted computer system having a display. The hosted computer system can be in the control of the check casher or in communication with the check casher. The check casher is able to view the high resolution images of the presented check, including watermarks, signatures, and informalities (e.g., incomplete information, abnormal additions, removed data). Additionally, magnetic ink character recognition (MICR) line data is examinable, the visual examination, as well as the MICR data is the financial credential information that may be contrasted to a check casher validating algorithm for scoring.

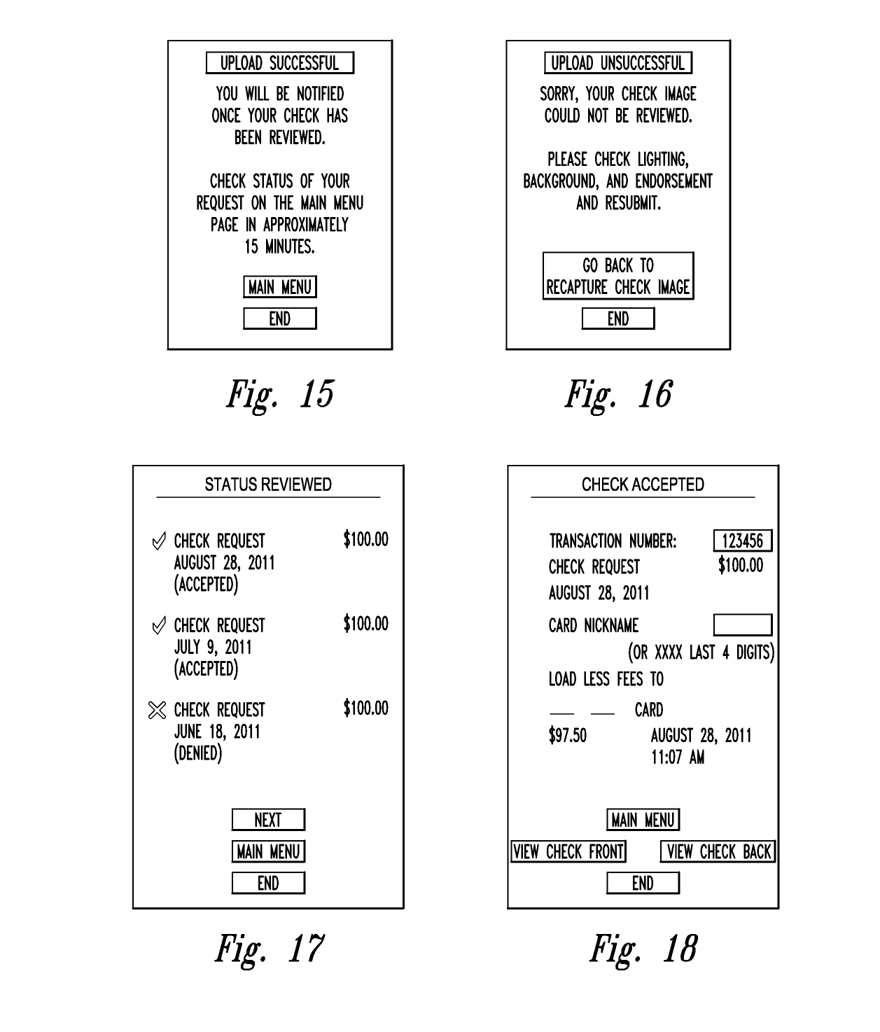

Once the images are transmitted to the check casher, the customer may have access to the status of the image transmission (FIG. 14). Once the transmission is successful, the customer may be notified of this fact by SMS (text messaging) or e-mail or a via a screen notice (such as illustrated in FIG. 15).

If the transmission of the check images is unsuccessful, the customer is so notified and allowed another opportunity to retransmit the check images (e.g., FIG. 16). The customer may also be given additional instructions to check lighting, background, or whether the check is properly endorsed.

If the transmission is successful, the check casher reviews the check and determines if the check is acceptable for cashing. Because the check casher is not a financial institution, the risk that the check is fraudulent or has insufficient funds rests on the check casher. If the check is accepted, the check casher will present the check, or an electronic version of the check, to its own bank, a financial institution. The check will be cashed and deposited into the check casher's account. Near simultaneously, the check casher will make the funds available to the customer via the customer's access account. If the check is fraudulent or otherwise “no good,” the check casher's account will be debited by its bank (plus any fees), but the check casher will not be able to debit the customers account except by any contractual remedy that has been established by the check casher and the customer.

The customer may check status and see that the check is approved (e.g., FIG. 17) and view the cashed check and load particulars (FIG. 18). According to one embodiment of the invention, the customer is notified (e.g., SMS messaging or e-mail or checks status of the transaction on the main menu, as illustrated in FIG. 6). At that point, the customer is either in the main menu “check status” or may do so shortly thereafter in which the customer may review the status (e.g., FIG. 17).

The check casher, through a card processor and the card issuer's bank, loads the entire proceeds of the check, less the check cashing fees, onto the customer access device. The consumer can review the particulars of the customer's now loaded access device (e.g., FIG. 18). Again referring also to FIG. 2, for approved checks, the check casher presents an electronic image of the check or an electronic check to its bank for deposit. The bank releases access to the full amount of the check into the check casher's account according to their standard business practices.

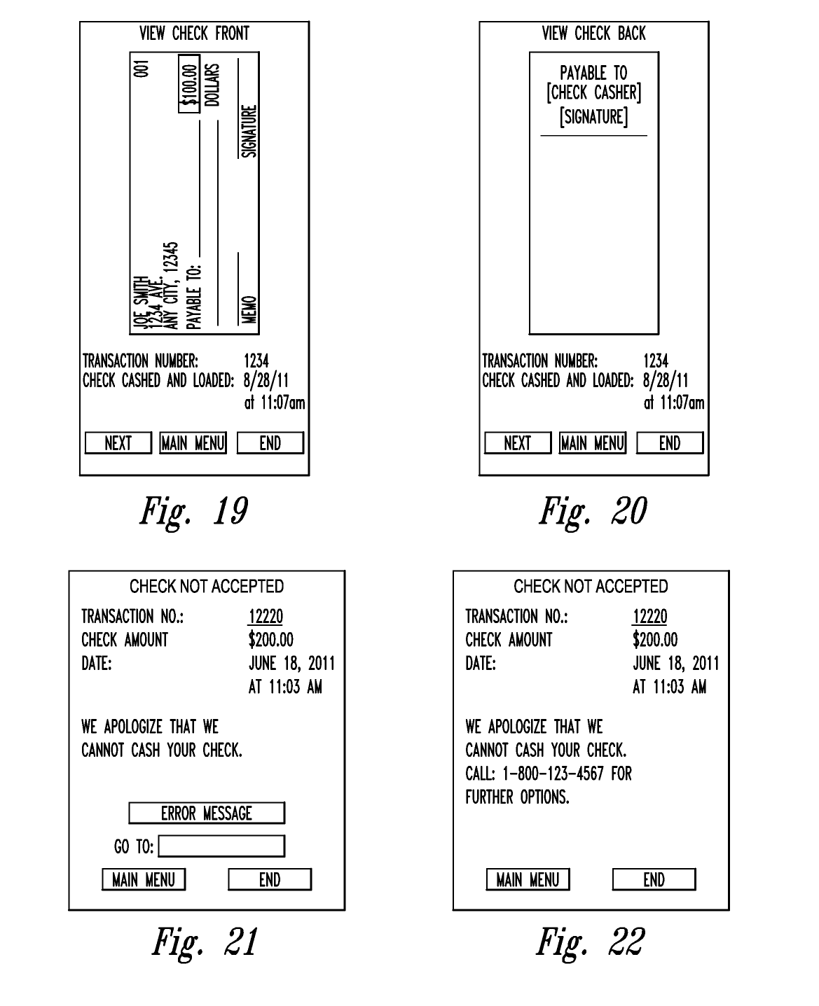

The customer may also optionally request to view the front and back images of the cashed check, such as those illustrated in FIGS. 19 and 20.

If, on the other hand, the customer's check is denied, the customer is so notified (again either by SMS, e-mail, phone, or screen shot (e.g., FIG. 21). The customer may terminate the transaction or may, optionally, be given further instructions, such as being provided a telephone number (or other contact information) to contact the check casher for further options as illustrated in FIG. 22.

Advantages of the present invention include consumers having near immediate access to the entire presented check, less check cashing fees, if accepted. Such full proceeds are immediately accessible by the consumer through a customer access device to which the full check amount, less check fees, are loaded. Thus, the consumer can have essentially immediate access to the funds without running to a bank or waiting to access the full amount of the check after the check has cleared. Further, checks that are presented over holidays and weekends (typically bank holidays) can now be presented for check cashing no matter how remote the consumer is as long as the consumer has access to a mobile smart device and the smart device is communicatively connected to a communications/data network.

The illustrated embodiments are only examples of the present invention and, therefore, are non-limitive. It is to be understood that many changes in the particular structure, materials, and features of the invention may be made without departing from the spirit and scope of the invention. Therefore, it is the Applicants' intention that their patent rights not be limited by the particular embodiments illustrated and described herein, but rather by the following claims interpreted according to accepted doctrines of claim interpretation, including the Doctrine of Equivalents and Reversal of Parts.

What is claimed is:

1. A method of cashing a check by a check casher for a fee via a mobile smart device, the method comprising:
receiving credential from a user via a smart device that is communicatively connected to a check casher; said credential information including user name and residence, smart device number, and a customer access device;
verifying the credential information and tying the smart device number to the customer access device;
inputting amount of a check to be cashed;
inputting agreement to the check casher's fee to cash the check;
endorsing the check;
capturing a high resolution image of the check front and back and transmitting said images to the check casher;
receiving confirmation that the full amount of the check, less the agreed to check cashing fees, is loaded onto the customer access device.

2. The method according to claim 1 wherein the credential information includes a user name and password and that the user name and password are entered prior to inputting the amount of the check to be cashed.

3. The method according to claim 1 wherein the high resolution image is in color.

4. The method according to claim 1 wherein the access device is a stored value card.

5. A system of cashing a check by a non federally-insured depository institution check casher via a mobile smart device, the system comprising:
a mobile smart device configured to capturing an image of a check to be presented by a consumer to a non-federally-insured depository institution and transmitting such image;
said mobile smart device having one or more processors configured to receive check data and identification data inputted from the consumer;
said mobile smart device having a transmitter configured to transmit the check image, and transmit and receive information about the check data and identification data;
a hosted computer system having one or more processors configured to communicate with a non-federally-insured depository institution check casher and the mobile smart device;
said hosted system including at least one display to forward the transmitted check image to the check casher, along with check data and consumer identification data; and
a computerized database containing validating data to compare the validating data with the check data and identification data.

6. A system for cashing a check via a mobile smart device; the system comprising: a computer system configured to execute program instructions:
receive credential information from a user;
validate the credential information;
receive a request to cash an electronic check;
receive and display a high resolution check image via a mobile smart device of a check written on a financial institution account to be presented for cashing;
obtain user account information from an account information database remote from the system, the user account information corresponding to credential information having been at least partially previously entered into the account information database independently from the computing system;
obtain presented check account information from a financial institution information database remote from the system;
compare the financial institution information database corresponding to the presented check account information; and
receive a determination whether to cash the check.
